(19) United States
(12) Patent Application Publication
(10) Pub. No.: US 2010/0169243 A1
(43) Pub. Date: Jul. 1, 2010

(54) METHOD AND SYSTEM FOR HYBRID TEXT CLASSIFICATION

(75) Inventors: Jiang Su, Ottawa (CA); Keith Bates, Toronto (CA); Biao Wang, Toronto (CA); Bo Xu, Toronto (CA)

Correspondence Address: VENABLE LLP, P.O. BOX 34385, WASHINGTON, DC, 20043-9998, US

(73) Assignee: Kibboko, Inc., Toronto (CA)

(21) Appl. No.: 12/344,480

(22) Filed: Dec. 27, 2008

(51) Int. Cl. G06F 15/18; G06F 17/30

(52) U.S. Cl. 706/12; 707/E17.044

(57) ABSTRACT

A computer-implemented system and method for text classification is provided that applies a hybrid approach for text classification. The system and method includes a text pre-processor which prepares unclassified articles in a format which can be read by a two-stage classifier. The classifier employs a hybrid approach. A keyword-based model achieves machine-labelling of the articles. The machine-labelled articles are used to train a machine learning model. New articles can be applied against the trained model, and classified.

### FIELD OF THE INVENTION

This invention relates generally to computer systems, and more particularly to a computer-implemented system and method of hybrid text classification to facilitate efficient information retrieval for users seeking information.

### BACKGROUND OF THE INVENTION

The World Wide Web contains millions of web pages. When browsing the web, it is often difficult to find content of interest from these millions of web pages. One common way to help a user locate web pages (e.g. articles or documents) with content of interest is to categorize web pages. For example, GOOGLE NEWS™ categorizes content (news articles) into a number of categories including categories such as “Business”, “Science/Technology” and “Entertainment”.

The problem of categorizing web pages by assigning a label to each web page is a challenging problem to providers of online catalogs or directories, search engines or other search systems, and the like. Past solutions have relied on the efforts of individuals to hand-label web pages. This is expensive due to the manual effort that is required, especially where specific knowledge of applicable information domains is required (e.g. health, financial, technological).

Search engines tend to return many pages in response to a query. Sometimes a generic query will return thousands of possible pages. As well, many pages identified by a search or recommendation engine are often irrelevant or only marginally relevant to the person carrying out the search. As such, use of search and recommendation engines tends to often be an inefficient use of time, produce poor results, or be frustrating.

Accurate categorization usually leads to better user experiences such as, for example, when a user enters a search query or selects a category and is able to view more relevant content (web pages) more directly. Labelling content or articles on the internet is one way that the performance of search and recommendation engines could be improved. Such labels could refer to some attribute of the article or content which is of interest to the person carrying out the search, or could indicate a category into which the article or content fits. There are some current methods of labelling:

### (a) Human or Manually Labelled Content

Content or articles can be labelled after a person has reviewed, at least in part, the article or content. There are some significant disadvantages to this approach. First it tends to be very expensive and time consuming. As well, it may be difficult to find people with appropriate domain expertise to carry out such labelling. Using people to manually label content has the further disadvantage that it does not scale up well to handle large numbers of articles. This approach suffers the further disadvantage that it is not well-suited to handle a continuous stream of requests to label articles.

### (b) Keyword-Based Labelling.

In this approach the words comprising the article are compared to keywords. Each instance of a label has specific keywords associated with it. When there is a sufficient match between the article and the keywords, the label associated with the keywords having a sufficient match is given to the article. This method tends to be efficient but it has some disadvantages. The error rate is quite high—many articles are improperly or incorrectly labelled. A second disadvantage is that keywords need to be update and revised—this also requires domain expertise, and is time consuming and expensive.

### (c) Machine-Learning Based Learning.

In this approach, models associating labels with content are developed iteratively through computer algorithms. Although this approach can produce reasonable results, this requires that the model be provided with training data sets. It can be expensive and difficult to produce such training data sets. A further disadvantage of this approach is that it can be sensitive to noise, outliers or idiosyncrasies in the articles requiring labelling or the training data set.

Sometimes these above approaches to labelling are combined. However such combinations in the prior art do not explore any synergies between the different approaches. They simply try one approach, and if this approach does not work, they try another approach or approaches.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention is directed to a computer-implemented system and method of hybrid text classification to facilitate efficient information retrieval for users seeking information. A computer-implemented system and method for text classification is disclosed that applies a hybrid approach for text classification. The system and method may include a text pre-processor which prepares unclassified articles in a format which can be read by a two-stage classifier. The classifier employs a hybrid approach. A keywords-based module achieves machine-labelling of the articles which is then used to train a machine learning module. New articles can be applied against the trained model, and classified.

A computer implemented method of text classification is provided comprising the steps of:
a. receiving a set of unlabelled and a set of initially labelled documents;
b. applying a keyword model to machine label the set of unlabelled documents, to produce a set of labelled (keyword) documents;
c. training a machine learning model using the set of labelled (keyword) documents and the set of initially labelled documents;
d. labelling a selected document using the machine learning model to produce an associated label; and
e. storing the selected document and the associated label.

The terms keyword model and machine learning model encompass any keyword based classification model and any learning machine model such as a supervised learning model, respectively.

A computer implemented method of text classification is also provided comprising the steps of applying a keyword model to apply a label to each document in a set of documents; and applying a machine learning model to refine the label.

Furthermore, an apparatus for text classification is provided comprising means for storing a set of unlabelled articles; means for pre-processing each article; means for applying a keyword model to machine label each article according to a keyword; means for scoring the accuracy of the machine label; and means for applying a machine learning model to refine the machine label for each article.

In another aspect of the invention, a memory for storing data for access by an application program being executed on a data processing system is provided comprising a database stored in memory, the database structure including information resident in a database used by said application program and a table stored in said memory serializing a set of documents and labels such that the labels may be updated based on applying a keyword model to machine label each document and a machine learning model to refine the label.

To the accomplishment of the foregoing and related ends, certain illustrative aspects of the invention are described herein in connection with the following description and the drawings. These aspects are indicative of various ways in which the invention may be practiced, all of which are intended to be covered by the present invention. Other advantages and novel features of the invention may become apparent from the following detailed description of the invention when considered in conjunction with the drawings.

### LIST OF FIGURES

FIG. 1 is a schematic block diagram illustrating the architecture of a text classification method and system according to an aspect of the present invention.

FIG. 2 is a diagram of the algorithm used by a text classification method and system according to an aspect of the present invention.

FIG. 3 is a schematic block diagram illustrating a system and method for text classification according to an aspect of the present invention.

FIG. 4 is a diagram illustrating an example user interface for designing a category and label-based classification scheme, suitable for use with a text classification method and system according to an aspect of the present invention.

FIG. 5 shows a basic computing system on which the invention can be practiced.

FIG. 6 shows the internal structure of the computing system of FIG. 7.

### DETAILED DESCRIPTION

The present invention relates to a computer-implemented system and method that applies a hybrid approach for text classification. The present invention arises in part from the insight that any labelled data set may improve the machine learning models, even if the labels are somewhat inaccurately labelled. As long as the labels are more accurate than a random allocation of labels, benefit can be found.

As used in this application, the terms “approach”, “module”, “component,” “classifier,” “model,” “system,” and the like are intended to refer to a computer-related entity, either hardware, a combination of hardware and software, software, or software in execution. For example, a module may be, but is not limited to being, a process running on a processor, a processor, an object, an executable, a thread of execution, a program, and/or a computer. By way of illustration, both an application running on a server and the server can be a module. One or more modules may reside within a process and/or thread of execution and a module may be localized on one computer and/or distributed between two or more computers. Also, these modules can execute from various computer readable media having various data structures stored thereon. The modules may communicate via local and/or remote processes such as in accordance with a signal having one or more data packets (e.g., data from one module interacting with another module in a local system, distributed system, and/or across a network such as the Internet with other systems via the signal).

The system and method for text classification is suited for any computation environment. It may run in the background of a general purpose computer. In one aspect, it has CLI (command line interface), however, it could also be implemented with a GUI (graphical user interface).

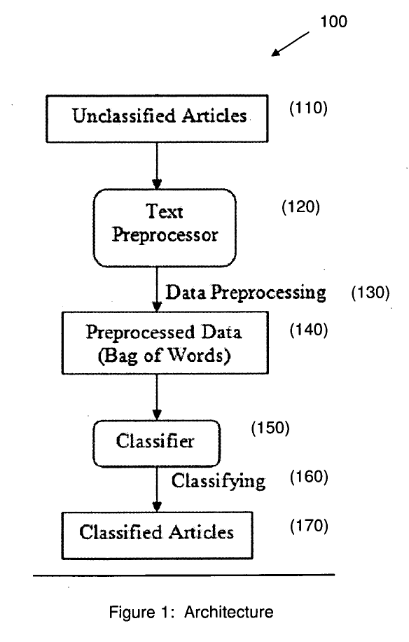

Referring to FIG. 1, the general architecture 100 of an aspect of the present invention is illustrated. A store of unclassified articles 110 (or web pages, documents or pieces of content) are maintained in a computer store 105 (or database 310, not shown). A module shown as a text pre-processor 120 analyzes each article and prepares it in a format which can be read by a classifier 150. This step is shown in FIG. 1 as data pre-processing 130. The pre-processed data 140 is, in one aspect, represented as a document vector and captured in a bag-of-words data structure. The classifier 150 may employ the hybrid approach described in further detail below, referred to in FIG. 1 as classifying 160. The resulting classified articles 170 are maintained in the computer store 105 (preferably, a table) for access by information retrieval interfaces 115 (not shown). After classifying 160, a label or classification is associated with each unclassified article 110.

The data pre-processing 130 may comprise stop-word deletion, stemming and title and link extraction, which transforms or presents each article as a document vector in a bag-of-words data structure. With stop-word deletion, selected “stop” words (i.e. words such as “an”, “the”, “they” that are very frequent and do not have discriminating power) are excluded. The list of stop-words can be customized. Stemming converts words to the root form, in order to define words that are in the same context with the same term and consequently to reduce dimensionality. Such words may be stemmed by using Porter's Stemming Algorithm but other stemming algorithms could also be used. Text in links and titles from web pages can also be extracted and included in a document vector. Also, to obtain the document vectors, during document parsing, non-alphabetic characters and mark-up tags may be discarded, and case-folding may be performed (i.e. all characters are converted to the same case-to lower case). Stemming, stop-word deletion and other pre-processing techniques are performed in one embodiment but are not strictly necessary to operate the invention. The bag-of-words structure ignores the ordering of words in a document. Only the frequency of words in a document is recorded, and structural information about the document is ignored. In the bag-of-words structure, a document is stored using the “sparse” format, that is, only the non-zero words are stored. This can significantly reduce the storage space requirements, where text data are known to be highly sparse. One possible way to presenting a document d as a document vector captures the word frequency information in each article or document: we define a set of words {w1, w2, . . . , wn}. An article or document is represented as a vector (f1, f2, . . . , fn), where fi is the word frequency of wi in the document, i=1, 2, . . . , n.

Preferably, the computer store 105 comprises a table for storing (serializing) the classifications of classified articles 170. At minimum, this table has a column called “articleID” and a column called “labelID”. For example, articleID may be a unique identifier corresponding to a single article source (e.g. URL). LabelID may be a number that corresponds to a category, such as “science”. A labelled document d is represented as d={w1, w2, . . . , wi, c}, where wi is a word which appears in the document and is drawn from a vocabulary V, and c is the class of the document. If w is the set of words in a document d, then a document is represented as {w,c}. A hash table or other data structure may used to facilitate compression and scalability.

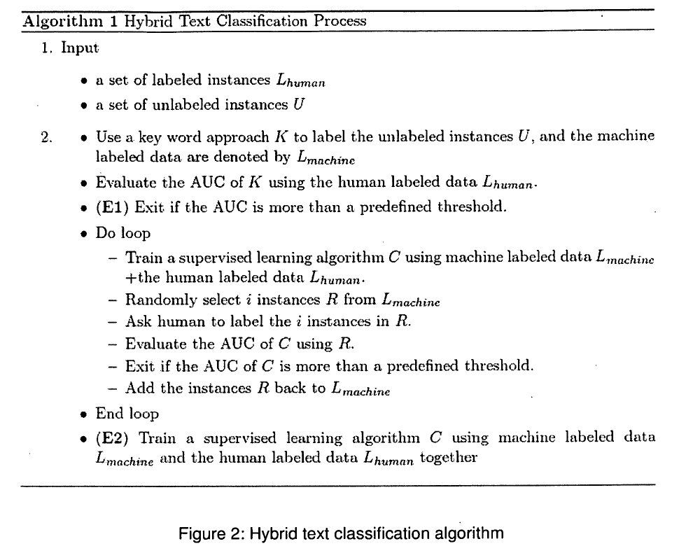

Turning now to FIG. 2, the hybrid learning algorithm of an aspect of the present invention is illustrated. Given a set of human-labelled instances (i.e. articles, pieces of content, documents, etc.), and a set of unlabelled documents, a keyword model is used to achieve machine labelling of the unlabelled documents. In a preferred embodiment, a measure called Area Under ROC Curve (AUC) is scored to determine if the machine labelling achieved by the keyword model is good enough, relative to the human-labelled documents. Note that the set of human-labelled instances is smaller than the set of unlabelled documents. In calculating the AUC, the human-labelled documents are also processed by the keyword model. If the labels determine by the keyword model are close enough to the human-determined labels, then the entire set of originally unlabelled documents, which have now been given labels by the keyword model, are deemed good enough, and the keyword model generated labels are used for all the instances of the originally unlabelled documents.

One widely used evaluation measurement for probability estimation is the AUC or area under ROC curve (Receiver Operating Characteristics). The ROC is originally used in signal detection and has been introduced into machine learning in recent years. The ROC curve can be plotted in the coordinate system by the true positive (TP) and the false positive (FP) pairs generated by a classifier. Thus, it can be used to measure the classifier's performance across the entire range of class distributions and error costs.

AUC can be calculated according the following formula:

AUC=((ΣRᵢ)−n₀(n₀+1)/2)/n₀ n₁), (Formula 32.1)
where n₀ and n₁ are the numbers of positive and negative respectively, and Rᵢ is the rank of the ith positive example in the ranked list.

The following will provide an example of the application of Formula 32.1 to calculation of AUC. The first step is to calculate the 2-class AUC for pairs of disparate labels. For example, assume there are three possible labels, Labels L1, L2 and L3 where L1=business; L2=music; and L3=cinema. The 2-class AUC for L1 and L2 would be calculated as follows:

$$2 \text{-} Class AUC ( L 1 , L 2 ) = ( ( \sum {R}_{i} ) - {n}_{0} ( {n}_{0} + 1 ) / 2 ) / {n}_{0} {n}_{1} ) , = Sum of the articles ' Rank ' s where the model generated Label is L 1 - ( Number of Articles Human labelled where the label is L {1}^{*} \\ ( Number of Artic les Human labelled where the label is L 1 + 1 ) / 2 / ( Number of Articles Human labelled where the label is L {1}^{*} Number of Articles Human labelled where the label is L 2 )$$

The next step is to calculate the 2-class AUC for the remaining pairs of disparate labels, i.e. 2-Class AUC(L2,L3) and 2-Class AUC(L1,L3).

The multiclass AUC is then determined according to the formula:

$$\begin{matrix}Multiclass AUC = ( \sum 2 \text{-} Class AUC ) / number of 2 \text{-} Class AUC ' s \\ = \sum 2 \text{-} Class AUC ) / 3\end{matrix}$$

Where the Multiclass AUC exceeds some threshold, the labels generated by the keyword module are judged to be appropriate enough, and the method and system will not go on to determining labels through a machine learning model.

If the pre-defined threshold is not reached, then the machine (keyword model) labelled documents plus the human-labelled documents are used to train (or update) a supervised learning algorithm or model. In a further preferred embodiment, after the model has been trained, a few documents are selected at random (or through another approach) and human-labelled. Alternatively, further human labelled documents can otherwise be added to the training set. The machine learning model is updated using this augmented training set. Again, the AUC (or other measure) is scored and compared to a pre-defined threshold. These steps can be repeated to further train the model until a pre-defined threshold is reached. Thereafter, new documents can be applied against the trained model, and classified.

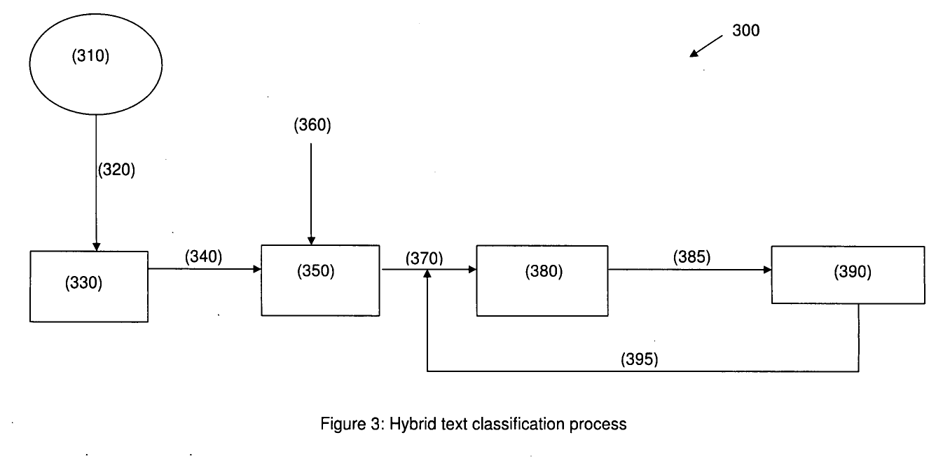

With reference to FIG. 3, a system and method for text classification according to a hybrid approach 300 is illustrated. This is analogous to classifier 150 shown in FIG. 1. A store of undifferentiated, unlabelled articles (or discrete pieces of content) a1 . . . an (shown as web raw data 320) are maintained in a database 310. A typical example database 320 could contain 1 million articles comprising web raw data 320. For the hybrid approach, a subset of these articles are human-labelled, such as for example, 100 articles. A data pre-processor module 330 (referred to above as text pre-processor 130) prepares the web raw data 320 into learning data 340, using the techniques described above in respect of bag-of-words. The learning data 340 are input into the keyword module 350, which comprises the first phase of the hybrid approach 300. The keyword module 350 generates a large amount of labelled data 370, for input for the learning machine module 380, which comprises the second phase of the hybrid approach 300.

Still with reference to FIG. 3, the keyword module 350 also takes an input shown as Wiki or personal knowledge 360, comprising a set of keywords (basic labels or categories such as “science”, “technology”, “movie”, “director”) generated by a human using a Wiki or his or her own knowledge. In one embodiment, a Term Frequency Inverse Document Frequency (TFIDF) weight method is used by the keyword module 350 to generate labelled data 370 (i.e. to classify web pages into different categories). The keyword module 350 assigns a document to a category with the highest TFIDF score. The “term frequency” refers to the number of times a given term appears in that document. This count may be normalized to prevent a bias towards longer documents (which may have a higher term frequency regardless of the actual importance of that

term in the document). The equation

$$t , {f}_{i , j} = \frac{{n}_{i , j}}{{\sum }_{k} {n}_{k , j}}$$

is used where ni,j is the number of occurrences of the considered term in document dj, and the denominator is the number of occurrences of all terms in document dj. The inverse document frequency is a measure of the general importance of the term (obtained by dividing the number of all documents by the number of documents containing the term, and then taking the
logarithm of that quotient).

$${idf}_{i} = log \frac{\vert D \vert}{\vert \{ {d}_{j} : {t}_{i} ∈ {d}_{j} \} \vert}$$

where |D|: total number of documents in the corpus and |{dⱼ:tᵢεdⱼ}|: number of documents where the term ti appears (that is n_{i,j}≠9). Then tfidf_{i,j}=tf_{i,j}·idfᵢ. Besides TFIDF, there are various term weighting approaches including Boolean weighting or term frequency (calculating how often a given keyword appears in the article). The purpose of the keyword module 350 is to create a large amount of labelled data 370 without intensive human effort. However, while these labels are expected to be much better than assigning labels at random, these labels may not be accurate and thus may require refinements. The labelled data 370 (preferably, a bag-of-words) is scored against the human-labelled subset of data and if required, inputted into the learning machine module 380 (both the machine-labelled and human-labelled documents may be inputted into the learning machine module 380). As noted above, in one embodiment, the AUC measure may be used for scoring. If the result is not good enough according to the scoring measure, then the learning machine module 380 is engaged. If the performance is good enough, then the system and method will stop and will label or classify the articles with the labels established by the keyword module 350.

The keyword module 350 does not require training data, but it is hard to ensure that keywords are used consistently. The output of the keyword module 350 is expected to include improperly labelled data (part of labelled data 370), which could be ameliorated by the learning machine module 380. Experimentation shows that including the keyword-based approach 152 is much better than random classification. For example, one experiment using just the keyword module 350 attempted to classify articles into one of eleven categories. The average precision achieved was 45.3% (for the eleven categories), and the highest precision was 100% (for one of the eleven categories).

With reference to FIG. 3, the learning machine module 380 works according to an iterative process: given a large amount of labelled data 370, a supervised learning algorithm may be trained on labelled data 370. Then, a set of machine-labelled data shown as the best article 390 will be selected at random or throught some other selection approach (shown as instance selection 385) and will be human-labelled (shown as human labelling 395). This human-labelled data are added back to labelled data 370. The learning machine module 380 is further trained, and the process of instance selection 385, human labelling 395 and training will be repeated until there is an acceptable performance according to a measure, for example in a preferred embodiment the Area under ROC Curve (AUC), described in greater detail, above.

Thus, with reference to FIG. 1, classifier 150 preferably includes two phases, a keyword-based approach 152 (analogous to the keyword module 350) combined with a supervised learning approach 154 (analogous to the learning machine module 380).

Turning now to FIG. 3, the method and system of the present invention according to a hybrid approach 300 is able to exploit the cheap, machine-labelled data (which can be large, in the example, 1 million articles) which is generated by the keyword module 350 for use by the learning machine module 380. The learning machine module 380 refines the labelling to achieve greater accuracy in an efficient, inexpensive way.

Still with reference to FIG. 3, the learning machine module 350 may employ a machine learning algorithm such as a supervised learning algorithm. In general a supervised learning algorithm generates a function that maps inputs (for example, document vector) to desired outputs (label). The classification problem is one standard formulation of supervised learning: the learner is required to learn (to approximate) the behavior of a function which maps a vector [X₁, X₂, . . . X_{N}] into one of several classes by looking at several input-output examples of the function. Formally, the classification problem can be stated as follows: given training data {(x₁, y₁), . . . , (xₙ, yₙ)} produce a classifier h: X→Y which maps an object xεX to its classification label yεY. For example, if xᵢ is some representation of an article or web page then y is a category label “Business”, “Science/Technology” or “Entertainment”.

For the learning machine module 350, the candidate algorithms besides Na\dot{i}ve Bayes include but are not necessarily limited to the following: Support Vector Machine, k-Nearest Neighbor (KNN), Concept Vector-based (CB), Singular Value Decomposition (SVD)—based and Decision Tree. Also, there are dozens of combination algorithms, including but not necessarily limited to CB+KNN (CB_KNN), Clustering+CB+K-Nearest Cluster (Cluster_CB_KNC), and Clustering+CB+KNN (Cluster_CB_KNN). The Na\dot{i}ve Bayes Classifier is a very popular algorithm due to its simplicity, computational efficiency and its surprisingly good performance for real-world problems. The “Na\dot{i}ve” attribute comes from the fact that the model assumes that all features are fully independent, which in real problems they almost never are. The invention is intended to encompass any learning machine algorithm such as a supervised learning algorithm.

Thus, the system and method of an aspect of the present invention has the ability to train a sufficiently accurate model with minimum human effort using cheap and sufficient unlabelled data. Unlabelled data can easily be acquired from and is abundant on the World Wide Web. In contrast, as noted above, hand-labelling requires human expert involvement, which is typically expensive and time-consuming, and is often sought to be minimized (with mixed results, given that accuracy can be compromised).

The hallmark of this hybrid approach is the connection between the keyword-based approach and the supervised learning approach. The keyword-based approach generates cheap machine-labelled data (equivalent to human-labelled) as input for the supervised learning approach. This results in a better and more efficient model without the expense of human-labelling. The system and method of an aspect of the present invention thereby improves or addresses the shortcomings of each of the traditional supervised learning approach (which has high accuracy) and the keyword-based approach.

A classifier is a system that performs a mapping from a feature space X to a set of labels Y. Basically what a classifier does is assign a pre-defined class label to a sample. The result of the system and method of an aspect of the present invention is a high quality classifier to apply to new content or articles. The input is an article. The output is a predicted category. The pairing of articles and classification may be used, for example, in a database for access by a search and recommendation engine.

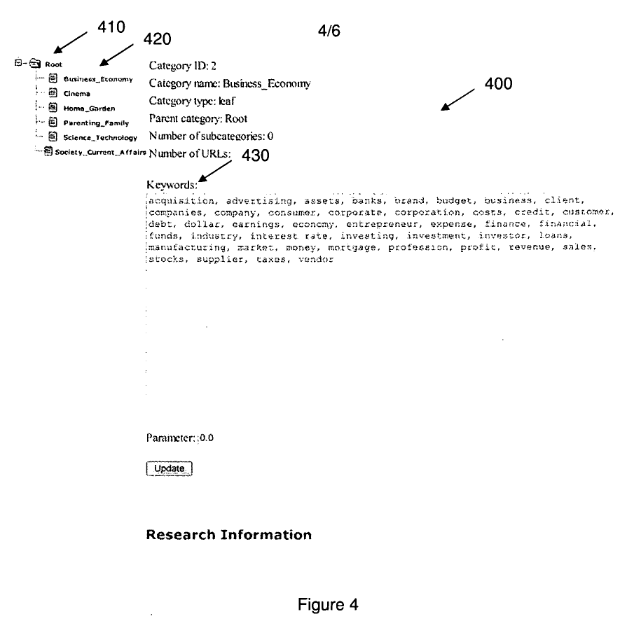

Turning now to FIG. 4, a diagram illustrating an example user interface 400 is shown, for designing a category and label-based classification scheme, suitable for use with a text classification method and system according to an aspect of the present invention. Categories 420 (or leaf nodes) and keywords 430 are defined based on design judgment (or are otherwise received into the system), and all the categories are organized as a category tree 410. Each document is classified into one of the categories 420 (leaf nodes) of the category tree 410. Each category 420 (leaf node) is treated as a label in text classification. The organization of the category tree 420 is for convenience and does not affect the working of the hybrid algorithm.

### Schemes

Some schemes have been extensively studied in the machine learning and data mining community. For example, Na\dot{i}ve Bayes, Bias From Mean, Per User Average, and Per Item Average are schemes that can be used because they are simple and extremely easy to implement.

i) Na\dot{i}ve Bayes

Na\dot{i}ve Bayes provides a probabilistic approach to classification. Given a query instance \vec{x}=<a₁,a₂, . . . ,aₙ> (e.g. set of articles or words), the Na\dot{i}ve Bayes approach to classification is to assign the so-called Maximum A Posteriori (MAP) target value v_{MAP} from the value set V (e.g. categories), namely,

$${v}_{MAP} = {arg max}_{{v}_{j} ∈ V} p ( {a}_{1} , {a}_{2} , … , {a}_{n} \vert {v}_{j} ) p ( {v}_{j} )$$

[Mitchell]. In the naive Bayes approach, we always assume that the attribute values are conditionally independent given the target value.

$$p ( {a}_{1} , {a}_{2} , … , {a}_{n} \vert {v}_{j} ) = {\prod }_{i} p ( {a}_{i} \vert {v}_{j} ) . \qquad ( 4.1 )$$

We get the naive Bayes classifier by applying the conditional independence assumption of the attribute values, as shown in Equation 4.2.

$${v}_{NB} = {arg max}_{{v}_{j} ∈ V} p ( {v}_{j} ) {\prod }_{i} p ( {a}_{i} \vert {v}_{j} ) \qquad ( 4.2 )$$

Na\dot{i}ve Bayes is believed to be one of the fastest practical classifiers in terms of training time and prediction time. It only needs to scan the training dataset once to estimate the various p(vⱼ) (e.g. probability of belonging in a category) and p(aᵢ|vⱼ) (e.g. conditional probability of belonging in a category) terms based on their frequencies over the training data and store the results for future classification. Thus, the hypothesis is formed without explicitly searching through the hypothesis space. In practice, we can employ the m-estimate of probability in order to avoid zero values of probability estimation [Mitchell]. Once the various p(vⱼ) and p(aᵢ|vⱼ) have been calculated for each label, then for a new unlabeled article or document, the probability is calculated for each label. The label with the highest calculated normalized probability is selected as the label for the article, and then stored in association with the article or document (or its identification number.)

The Na\dot{i}ve Bayes scheme has been found to be useful in many practical applications.

Although the conditional independence assumption of Na\dot{i}ve Bayes is unrealistic in most cases, it is competitive with many learning algorithms and even outperforms them in some cases. When the assumption of conditional independence of the attribute values is met, na\dot{i}ve Bayes classifiers output the MAP classification. Even when the assumption is not met, Na\dot{i}ve Bayes classifiers still work quite effectively. It can be shown that Na\dot{i}ve Bayes classifiers could give the optimal classification in most cases even in the presence of attribute dependence [Mitchell]. For example, although the assumption of conditional independence is violated in text classification, since the meaning of a word is related to other words and the meaning of a sentence or an article depends on how the words work together, Na\dot{i}ve Bayes is one of the most effective learning algorithms for such problems.

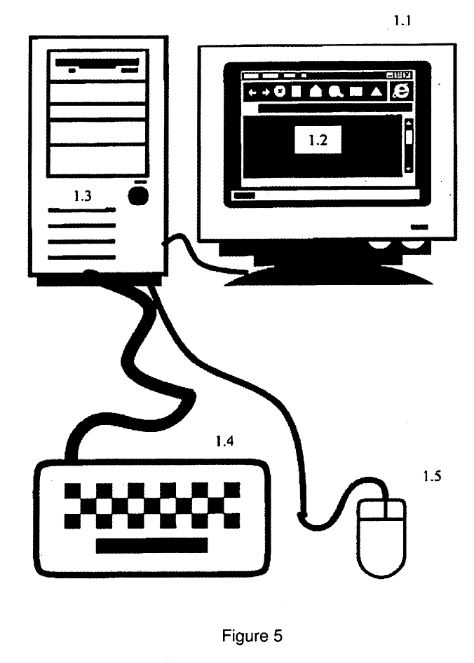

FIG. 5 shows a basic computer system on which the invention might be practiced. The computer system comprises of a display device (1.1) with a display screen (1.2). Examples of display device are Cathode Ray Tube (CRT) devices, Liquid Crystal Display (LCD) Devices etc. The computer system can also have other additional output devices like a printer. The cabinet (1.3) houses the additional essential components of the computer system such as the microprocessor, memory and disk drives. In a general computer system the microprocessor is any commercially available processor of which x86 processors from Intel and 680X0 series from Motorola are examples. Many other microprocessors are available. The computer system could be a single processor system or may use two or more processors on a single system or over a network. The microprocessor for its functioning uses a volatile memory that is a random access memory such as dynamic random access memory (DRAM) or static memory (SRAM). The disk drives are the permanent storage medium used by the computer system. This permanent storage could be a magnetic disk, a flash memory and a tape. This storage could be removable like a floppy disk or permanent such as a hard disk. Besides this the cabinet (1.3) can also house other additional components like a Compact Disc Read Only Memory (CD-ROM) drive, sound card, video card etc. The computer system also has various input devices like a keyboard (1.4) and a mouse (1.5). The keyboard and the mouse are connected to the computer system through wired or wireless links. The mouse (1.5) could be a two-button mouse, three-button mouse or a scroll mouse. Besides the said input devices there could be other input devices like a light pen, a track ball etc. The microprocessor executes a program called the operating system for the basic functioning of the computer system. The examples of operating systems are UNIX, WINDOWS and DOS. These operating systems allocate the computer system resources to various programs and help the users to interact with the system. It should be understood that the invention is not limited to any particular hardware comprising the computer system or the software running on it.

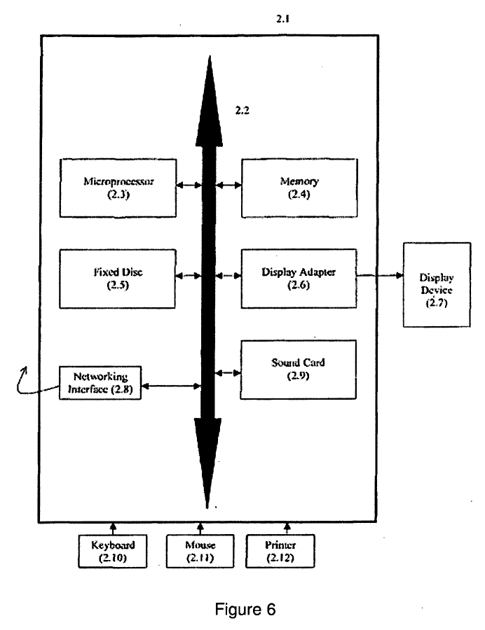

FIG. 6 shows the internal structure of the general computer system of FIG. 5. The computer system (2.1) consists of various subsystems interconnected with the help of a system bus (2.2). The microprocessor (2.3) communicates and controls the functioning of other subsystems. Memory (2.4) helps the microprocessor in its functioning by storing instructions and data during its execution. Fixed Drive (2.5) is used to hold the data and instructions permanent in nature like the operating system and other programs. Display adapter (2.6) is used as an interface between the system bus and the display device (2.7), which is generally a monitor. The network interface (2.8) is used to connect the computer with other computers on a network through wired or wireless means. The computer system might also contain a sound card (2.9). The system is connected to various input devices like keyboard (2.10) and mouse (2.11) and output devices like printer (2.12). Various configurations of these subsystems are possible. It should also be noted that a system implementing the present invention might use less or more number of the subsystems than described above.

The labels generated through the hybrid text classification method and system described above can be used by a search or recommendation engine, to improve the performance of the search or recommendation engine.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A computer implemented method of text classification comprising the steps of:
a. receiving a set of unlabelled and a set of initially labelled documents;
b. applying a keyword model to machine label the set of unlabelled documents, to produce a set of labelled (keyword) documents;
c. training a machine learning model using the set of labelled (keyword) documents and the set of initially labelled documents;
d. labelling a selected document using the machine learning model to produce an associated label; and
e. storing the selected document and the associated label.

2. A computer implemented method of text classification comprising the steps of:
a. receiving a set of unlabelled and a set of initially labelled documents;
b. applying a keyword model to machine label the set of unlabelled documents, to produce a set of labelled (keyword) documents;
c. scoring the set of labelled (keyword) documents;
d. if the score is less than a pre-defined threshold, then:
i. training a machine learning model using the set of labelled (keyword) documents and the set of initially labelled documents;
ii. labelling a selected document using the machine learning model to produce an associated label; and
iii. storing the selected document and the associated label.

3. A computer implemented method of text classification according to claim 1 further comprising the step of pre-processing a set of unlabelled and a set of initially labelled documents in a vector format {w,c}.

4. A computer implemented method of text classification according to claim 1 where the machine learning model is selected from one of Na\dot{i}ve Bayes, Bias From Mean, Per User Average, or Per Item Average.

5. A computer implemented method of text classification according to claim 1 where the keyword model employs a Term Frequency Inverse Document Frequency weight method to generate labelled data.

6. A computer implemented method of text classification according to claim 2 further comprising the step of scoring two or more selected documents and re-training the machine learning model by receiving at least one further human-labelled document and using the at least one further human labelled document to update the machine learning model, and then further calculating the scoring of the two or more selected documents until the pre-defined threshold is reached.

7. A search or recommendation engine utilizing labels generated according to the method of claim 1.

8. A computer implemented method of text classification according to claim 2 wherein the scoring step is accomplished by using AUC and the method includes the step of receiving the pre-defined threshold.

9. A computer implemented method of text classification comprising the steps of:
a. applying a keyword model to create a label for each document in a set of documents; and
b. applying a machine learning model to refine the label.

10. A computer implemented method of text classification according to claim 1 wherein the keyword model assigns a keyword based on TFIDF.

11. A computer implemented method of text classification according to claim 1 wherein the machine learning model is a supervised learning model.

12. An apparatus for text classification comprising:
a. means for storing a set of unlabelled articles;
b. means for pre-processing each article;
c. means for applying a keyword model to machine label each article according to a keyword;
d. means for scoring the accuracy of the machine label; and
e. means for applying a machine learning model to refine the machine label for each article.

13. A computer readable memory having recorded thereon statements and instructions for execution by a computer to carry out the method of claim 1.

14. A memory for storing data for access by an application program being executed on a data processing system, comprising:
a database stored in said memory, said data structure including information resident in a database used by said application program and including:
a table stored in said memory serializing a set of documents and associated labels such that each label may be updated by applying a keyword model to create an initial machine label each document and a machine learning model to refine the initial machine label.

15. A computer implemented method of text classification according to claim 2 further comprising the step of pre-processing a set of unlabelled and a set of initially labelled documents in a vector format {w,c}.

16. A computer implemented method of text classification according to claim 2 where the machine learning model is selected from one of Na\dot{i}ve Bayes, Bias From Mean, Per User Average, or Per Item Average.

17. A computer implemented method of text classification according to claim 2 where the keyword model employs a Term Frequency Inverse Document Frequency weight method to generate labelled data.

18. A search or recommendation engine utilizing labels generated according to the method of claim 2.

19. A computer implemented method of text classification according to claim 2 wherein the keyword model assigns a keyword based on TFIDF.

20. A computer implemented method of text classification according to claim 9 wherein the keyword model assigns a keyword based on TFIDF.

21. A computer implemented method of text classification according to claim 2 wherein the machine learning model is a supervised learning model.

22. A computer implemented method of text classification according to claim 9 wherein the machine learning model is a supervised learning model.
